(19) United States
(12) Patent Application Publication
(10) Pub. No.: US 2012/0014041 A1
(43) Pub. Date: Jan. 19, 2012

(54) MEDIUM VOLTAGE CIRCUIT-BREAKER FOR OUTDOOR USE

(75) Inventors: Dietmar Gentsch, Ratingen (DE); Wenkai Shang, Ratingen (DE)

(73) Assignee: ABB Technology AG, Zurich (CH)

(21) Appl. No.: 13/183,877

(22) Filed: Jul. 15, 2011

(30) Foreign Application Priority Data
Jul. 15, 2010 (EP) 10007320.4

(51) Int. Cl. H02B 1/26

(52) U.S. Cl. 361/626

(57) ABSTRACT

A medium voltage circuit-breaker for outdoor applications includes at least one pole part with inner electrical contacts, operated by actuator means via a jackshaft arrangement accommodated in an enclosed main housing having a mounting surface. The pole part is removably attached to the mounting surface and an elastomeric sealing ring is arranged between the end surface of the pole part and a corresponding mounting surface of the main housing. A section of the sealing ring includes a solid porosity material, for air exchange between the inside of the main housing and the environment.

### RELATED APPLICATION

This application claims priority under 35 U.S.C. §119 to European Patent Application No. 10007320.4 filed in Europe on Jul. 15, 2010, the entire content of which is hereby incorporated by reference in its entirety.

### FIELD

The present disclosure relates to voltage circuit breakers, such as, a medium voltage circuit-breaker for outdoor applications that includes at least one pole part with inner electrical contacts operated by actuator means via a jackshaft arrangement accommodated in an enclosed main housing having a mounting surface, on which the pole part is removable attached.

### BACKGROUND INFORMATION

Medium-voltage circuit-breakers interrupt current by creating and extinguishing an arc in a vacuum chamber. Modern vacuum circuit-breakers tend to have a longer life time than former air or oil circuit-breakers. Vacuum circuit-breakers replaced air circuit-breakers at least for indoor applications and were not suitable for outdoor applications.

WO 93/10547 A1 discloses a medium voltage circuit-breaker for indoor and for outdoor use. The circuit breaker has one electrical pole per phase, wherein each pole part includes a feed-through insulator containing a vacuum chamber to which a metal tube is mechanically and electrically connected. The metal tube contains a control rod for operating a movable electrical contact of a pair of electrical contacts which are accommodated inside the vacuum chamber.

Each feed-through insulator of a corresponding pole part is attached to a common main housing containing a jackshaft arrangement for transferring the actuating force generated by an actuator unit to each pole part for switching the electrical contacts. The metal tube inside the pole part which usually comprises, (e.g., consists of) a synthetic insulating material has an opening on the lower end. This opening is provided for feed the push rod of the jackshaft arrangement through the metal tube in the direction of the pair of electrical contacts.

Since this so-called open system does not avoid an ingress of moisture in the pole part, additional dynamic sealing means are necessary. Therefore, various embodiments of sliding blocks are integrated inside the upper or lower portion inside the metal tube.

The product information “Outdoor life tank vacuum circuit-breaker” (ABB Limited, 2009) discloses another medium voltage circuit breaker arrangement for outdoor applications. However, this application includes a sealed system. A closed main housing is provided which is attached to the ground via a supporting frame. The enclosed main housing is made of mild steel and accommodates a spring operated mechanism that is mechanically linked to three pole parts removable attached on an upper mounting surface of the main housing. To accommodate a jackshaft arrangement, an additional cross bar-shaped housing part is provided. Each pole part contains an inner vacuum interrupter insert with a pair of electrical contacts as described above and it is attached to the main housing in a sealed manner.

For outdoor applications of embedded pole parts, the break down voltage is dependent on the temperature and also the relative humidity. Furthermore, the weather condition changes in the year and the tracking and dielectric performance of the insulating parts of the circuit-breaker depend on said changing weather conditions.

Therefore, it is an object of the present disclosure to provide a medium voltage circuit breaker for outdoor applications having a constant dielectric performance independent from the weather conditions.

### SUMMARY

An exemplary medium voltage circuit-breaker for outdoor applications is disclosed. The method comprises at least one pole part with inner electrical contacts, operated by actuator means via a jackshaft arrangement accommodated in an enclosed main housing having a mounting surface, on which the pole part is removable attached; and an elastomeric sealing ring arranged between the end surface of the pole part and a corresponding mounting surface of the main housing, wherein at least a section of the sealing ring includes a solid porosity material, air exchange between an inside of the main housing and the environment.

### BRIEF DESCRIPTION OF THE DRAWINGS

The foregoing and other aspects of the present disclosure will become apparent following the detailed description of the present disclosure when considered in conjunction with the enclosed drawings, wherein:

FIG. 1 illustrates a schematic side view of a medium voltage circuit-breaker arrangement for outdoor use in accordance with an exemplary embodiment; and

FIG. 2 illustrates a schematic axial section around the sealing ring of the circuit breaker of FIG. 1 in accordance with an exemplary embodiment.

### DETAILED DESCRIPTION

According to an exemplary embodiment of the present disclosure a medium voltage circuit-breaker for outdoor applications can be provided with an elastomeric sealing ring between the front side of the pole part and the corresponding mounting surface of the enclosed main housing, wherein at least a section of said sealing ring consists of a solid porosity material.

Due to the special porosity material section of the sealing ring a permanent and defined air exchange between the inside of the main housing and the environment is possible. The specific elastomeric sealing ring can ensure constant air conditions around the critical space inside the pole part.

The elastomeric sealing ring can coaxially surround a push rod of the jackshaft arrangement. Thus, the push rod extends through the sealing ring in a constant radial distance.

In order to reach a sufficient electrical insulation between the movable electrical contact of the pole part and its operating means the intermediate push rod can comprise (e.g., consists of) a synthetic insulating material, or inorganic porosity material.

In contrast, the special sealing ring according to the present disclosure can be designed as a flexible rubber bellow. A section of said bellow can comprise (e.g., consists of) the solid porosity material according to the present disclosure. Preferably, the porosity solid material is different from the rubber material of the sealing ring in order to ensure the permanent air exchange. However, the porosity solid material can comprise (e.g., consists of) a molded synthetic material, e. g. polyethylene foam.

According to another exemplary embodiment of the present disclosure, the enclosed main housing is can be made of bended sheet metal in a welded design. In order to ensure a stable construction the sheet metal comprises (e.g., consists of) steel.

For a three-phase application three single pole parts with corresponding elastomeric sealing rings as described above can be attached to the mounting surface of a common enclosed main housing. Due to the common main housing design less single parts are necessary for the outdoor circuit-breaker arrangement.

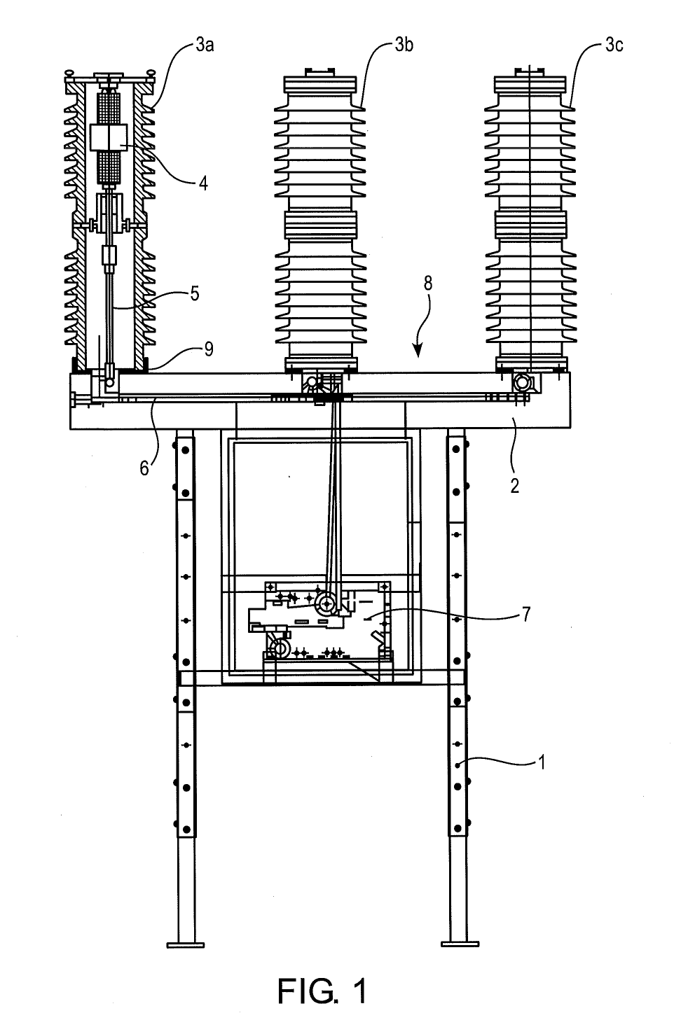

FIG. 1 illustrates a schematic side view of a medium voltage circuit-breaker arrangement for outdoor use in accordance with an exemplary embodiment. As shown in FIG. 1 comprises (e.g., consists of) a supporting construction 1, and enclosed main housing 2 and three single pole parts 3a-3c in order to form a three-phase application for outdoor use.

The supporting construction 1 forms a frame for the enclosed main housing 2 to hold the circuit-breaker arrangement in place in relation to the ground, which ensures a defined distance thereto.

Inside each pole part 3a-3c a vacuum interruption chamber 4 can be arranged. The vacuum interruption chamber 4 can accommodates a pair of—not shown—electrical contacts under vacuum conditions. One contact of the pair of electrical contacts is axially movable and operated by a push rod 5 which is a part of a jackshaft arrangement 6 for mechanically connecting the movable electrical contact of each pole part 3a to 3c with a common electromagnetic actuator 7. The jackshaft arrangement 6 can be accommodated in the closed main housing 2 in a sealed manner. Each pole part 3a-3c is removably attached to a mounting surface 8 of the main housing 2.

A special elastomeric sealing ring 9 is arranged between the front side of each pole part 3a to 3c and to the corresponding mounting surface 8 of the main housing.

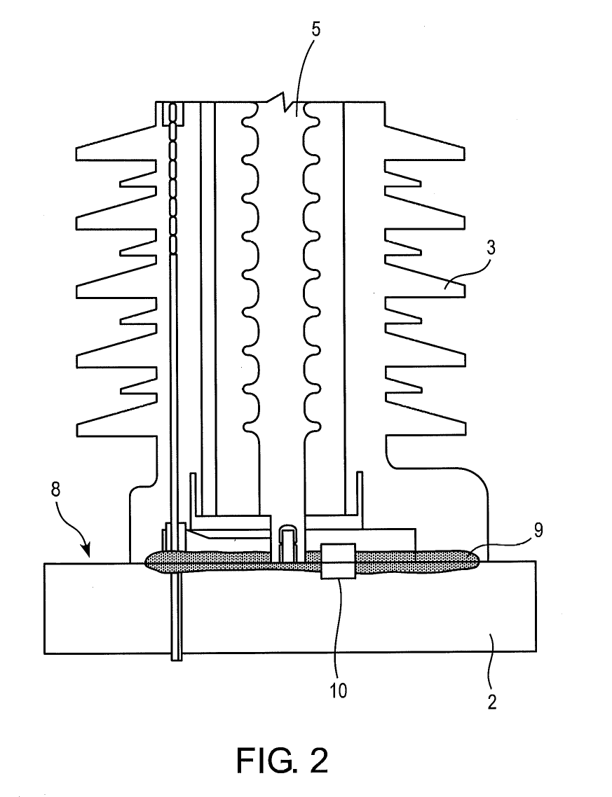

FIG. 2 illustrates a schematic axial section around the sealing ring of the circuit breaker of FIG. 1 in accordance with an exemplary embodiment. As shown in FIG. 2, the special elastomeric sealing ring 9 includes a section 10 which comprises (e.g., consists of) a solid porosity material. The solid porosity material ensures an air exchange between the inside of the pole part 3 (exemplary) and the outdoor environment.

As shown, the sealing ring 9 coaxially surrounds the push rod 5 which comprises (e.g., consists of) a synthetic insulation material. The sealing ring 9 comprises (e.g., consists of) elastomeric material and the special section 10 comprises (e.g., consists of) another synthetic material which ensures the desired solid porosity characteristic.

The present disclosure is not limited by the preferred embodiment as described above which is presented as an example only but can be modified in various ways within the scope of protection defined by the following patent claims. Especially, applications with less or more than three pole parts are possible in connection with a common enclosed main housing.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SIGNS

1 supporting construction
2 main housing
3 pole part
4 vacuum interrupt chamber
5 push rod
6 jackshaft arrangement
7 electromagnetic actuator
8 mounting surface
9 sealing ring
10 porosity section

What is claimed is:

1. A medium voltage circuit-breaker for outdoor applications comprising:
at least one pole part with inner electrical contacts, operated by actuator means via a jackshaft arrangement accommodated in an enclosed main housing having a mounting surface, on which the pole part is removable attached; and
an elastomeric sealing ring arranged between the end surface of the pole part and a corresponding mounting surface of the main housing, wherein at least a section of the sealing ring includes a solid porosity material, air exchange between an inside of the main housing and the environment.

2. The medium voltage circuit-breaker according to claim 1,
wherein the sealing ring coaxially surrounds a pushrod of the jackshaft arrangement.

3. The medium voltage circuit-breaker according to claim 2,
wherein the push rod includes a synthetic insulation material.

4. The medium voltage circuit-breaker according to claim 1,
wherein the porosity material of the sealing ring's section includes a molded synthetic material, or inorganic porosity material.

5. The medium voltage circuit-breaker according to claim 1,
wherein the sealing ring is designed as a flexible rubber bellow.

6. The medium voltage circuit-breaker according to claim 1,
wherein the enclosed main housing is made of bended sheet metal in a welded design.

7. The medium voltage circuit-breaker according to claim 1,
wherein three single pole parts with corresponding elastomeric sealing rings are attached to the mounting surface of a common enclosed main housing in order to form a 3-phase application.

8. The medium voltage circuit-breaker according to claim 1,
wherein a pair of inner electrical contacts of each pole part is arranged in a vacuum interruption chamber which is embedded in insulating material.

9. The medium voltage circuit-breaker according to claim 1,
wherein a spring drive single or double coil permanent magnetic actuator drives the moving contacts directly or indirectly of the circuit breaker.
